(19) United States
(12) Patent Application Publication
(10) Pub. No.: US 2006/0285851 A1
(43) Pub. Date: Dec. 21, 2006

(54) Optical transceivers and methods to reduce interference in optical transceivers

(76) Inventors: Jiaxi Kan, San Jose, CA (US); Joshua Oen, Fremont, CA (US); Craig Schulz, Fremont, CA (US)

Correspondence Address: HANLEY, FLIGHT & ZIMMERMAN, LLC, 20 N. WACKER DRIVE, SUITE 4220, CHICAGO, IL, 60606, US

(21) Appl. No.: 11/154,432

(22) Filed: Jun. 16, 2005

(51) Int. Cl. H04B 10/00

(52) U.S. Cl. 398/135

(57) ABSTRACT

Optical transceivers and methods to reduce interference in optical transceivers are disclosed. A disclosed optical transceiver comprises: a converter; a laser diode driver in communication with the converter; and at least one absorber defining a cavity dimensioned to receive the laser diode driver to reduce electromagnetic interference originating with the laser diode driver.

### FIELD OF THE DISCLOSURE

This disclosure relates generally to optical transceivers, and, more particularly, to optical transceivers and methods to reduce interference in optical transceivers.

### BACKGROUND

Telecommunication, computer networking and other applications have increasingly moved toward fiber optic connections as the push for speed and increased bandwidth has proceeded. This move toward optical networking has given rise to increased demand for optical components. At the same time, the ever present desire for miniaturization has increasingly led to locating components in close proximity to one another in increasingly small packages. Packing electronics in close quarter has led to cross-talk and electromagnetic interference (EMI) problems.

Known ways to suppress noise producing microwave emissions (and, thus, EMI) in transceivers includes shielding electrically noisy components with grounded housings, or grounding the component case itself to prevent such emissions. However, such prior art solutions require significant area on the printed circuit board (PCB) for grounding moats, etc. and are, thus, not consistent with the desire to miniaturize. Further, in some applications, the case/package of the noisy component cannot be grounded because it must be electrically isolated or biased to a non-zero voltage.

### BRIEF DESCRIPTION OF THE DRAWINGS

FIG. 1 is a schematic illustration of a prior art optical transceiver.

FIG. 2 is a schematic illustration of an example optical transceiver constructed in accordance with the teachings of the invention.

FIG. 3 is a more detailed perspective view of an example optical transceiver constructed in accordance with the teachings of the invention, but showing the microwave absorber exploded from the transceiver.

FIG. 4 is a view similar to FIG. 3, but showing the microwave absorber positioned within the transceiver.

### DETAILED DESCRIPTION

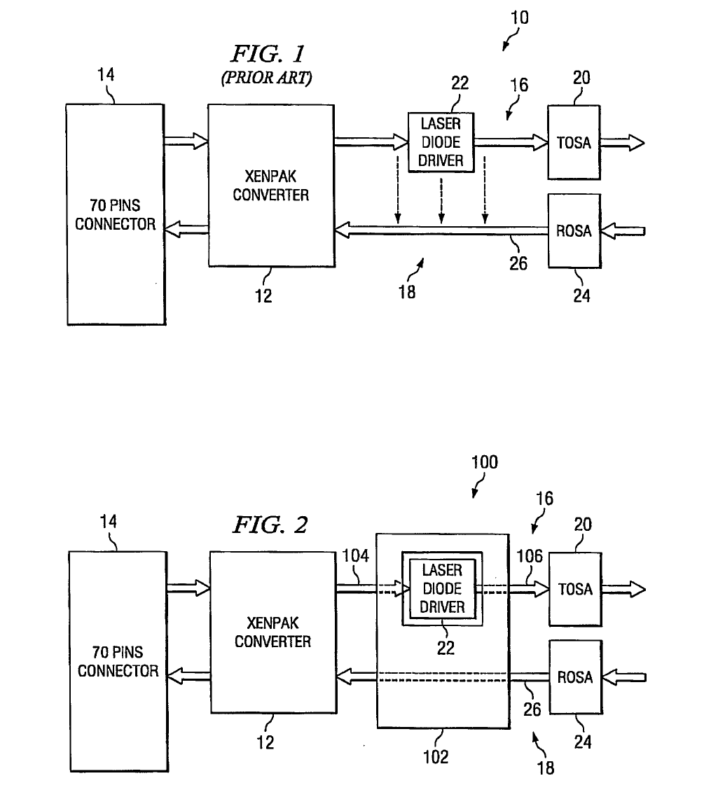

An example prior art optical transceiver is shown in FIG. 1. In the example of FIG. 1, the transceiver 10 includes a converter 12 (sometimes referred to in the art as a Serder or serial converter device). In the illustrated example, the converter 12 operates in accordance with the XENPAK Multisource Agreement (MSA) and, thus, conforms to the 10 Gigabit Ethernet (10 GbE) standard as promulgated under IEEE 802.3ae. In keeping with the XENPAK specifications, the XENPAK converter 12 serializes four lanes of 3.125 Gb/s signals from a 70 pin connector 14 into a 10 Gb/s signal that is fed into a laser diode diver 22. The XENPAK converter 12 also de-serializes a 10 Gb/s that is from ROSA 24 into four lanes of 3.125 Gb/s signal that are fed to the 70 pins connector 14. The XENPAK converter 12 is interfaced to a 70 pin connector 14 for attachment to a host device.

The example transceiver of FIG. 1 includes a transmit chain 16 and a receive chain 18. The transmit chain 16 includes a transmit optical sub-assembly (TOSA) 20, which is a modular device including a laser diode for transmitting optical signals. A laser diode driver 22 is coupled between the converter 12 and the TOSA 20. The laser diode driver 22 converts electrical drive signals received from the converter 12 into drive signals for a laser diode (not shown) associated with the TOSA 20. The receive chain includes a receive optical sub-assembly (ROSA) 24, which includes at least one photodiode for converting received optical signals into electrical signals. The electrical signals are output, typically via a differential communication line 26, to the converter 12. The converter 12 conditions (e.g., serializing, de-serializing, coding, controlling, monitoring, etc.) the signals received from the ROSA 24 and the 70 pin connector 14, and delivers them to the laser diode driver 22 and to the host device (not shown) via the 70 pin connector 14.

Typically, the output signals of the ROSA 24 are very weak. Therefore, they are very susceptible to interference. As shown in FIG. 1, the transmit chain 16 and the receive chain 18 are typically parallel and in close proximity to one another. As such, cross-talk from the transmit chain 16 to the receive chain 18 (as represented by the dotted arrows in FIG. 1) can degrade the quality of the signals received from the ROSA 24. This is particularly true because the laser diode driver 22 is typically a high power device (e.g., about 0.5 Watts). The signals from the ROSA 24 typically require interference to be maintained at less than, for example, 2 mV, peak-to-peak. Thus, the presence of the high power laser diode driver 22 raises a serious interference issue.

FIG. 2 is a schematic illustration of an example optical transceiver 100 constructed in accordance with the teachings of the invention. The transceiver 100 has many of the same structures as the prior art transceiver 10 discussed above. Thus, for example, it includes a converter 12 (e.g., a XENPAK converter) with a 70 pin connector 14 for coupling to a host device, a transmit chain 16 including a laser diode driver 22 and a TOSA 20, and a receive chain 18 which includes a ROSA 24 delivering low level signals to the converter 12 via a differential communication line 26. As mentioned above, the proximity of the high power laser diode driver 22 to the differential communication line 26 raises a cross-talk interference issue that, without further intervention, can significantly degrade the signal-to-noise ratio of the signals output by the ROSA 24.

In order to reduce cross-talk and/or other EMI originating with the laser diode driver 22, the transceiver 100 is provided with an absorber 102. In the illustrated example, the absorber 102 is a broadband absorber which defines a cavity dimensioned to receive the laser diode driver 22 when the absorber 102 is positioned upon the PCB of the transceiver 100. The height of the absorber 102 is preferably selected to be at least as tall as the laser diode driver 22. Thus, the absorber 102 surrounds the sides of the driver 22 to thereby suppress EMI emissions from the driver 22 to reduce electromagnetic interference with surrounding components such as the communication line 26.

Unlike prior art approaches to EMI suppression which required dedicated PCB area for the EMI suppression components (e.g., grounding moats, etc.); the absorber 102 can be employed without consuming any PCB real estate or requiring expansion of the PCB. Instead, the absorber 102 is structured to overlie at least a portion of the transmit chain 16 and at least a portion of the receive chain 18. In the illustrated example, the absorber 102 surrounds the laser diode driver 22, while overlying a portion of the electrical connector/driver line 104 coupling the converter 12 to the laser diode driver 22, overlying a portion of the electrical connector 106 coupling the laser diode driver 22 to the TOSA 20, and overlying a portion of the differential communication link 26 coupling the ROSA 24 to the converter 12 to thereby reduce interference between the emissions of the driver 22 and the communication link 26. In an example implementation of the circuit of FIG. 2, the absorber 102 reduced interference with the output signals from the ROSA 24 by about 1 decibel (db).

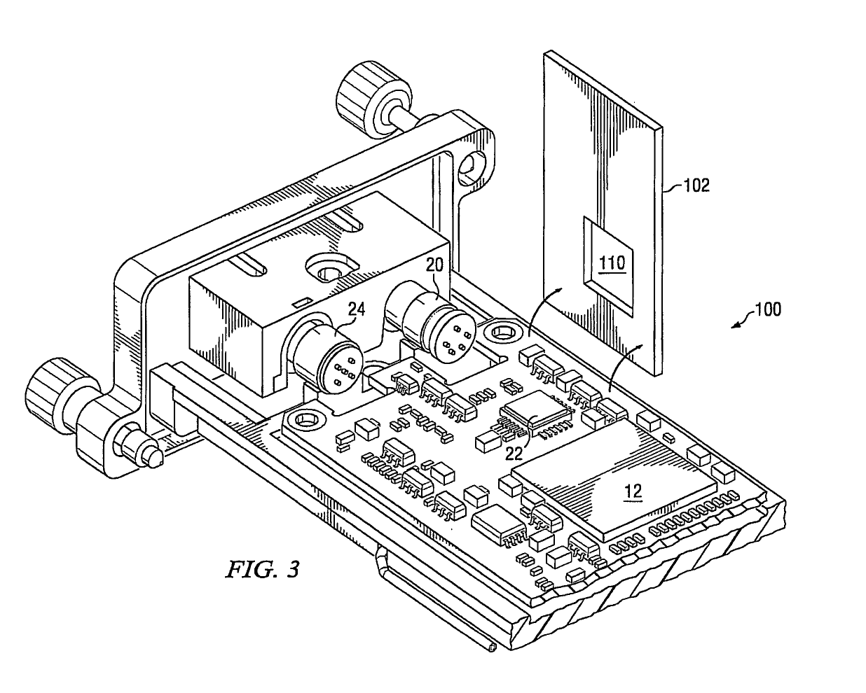

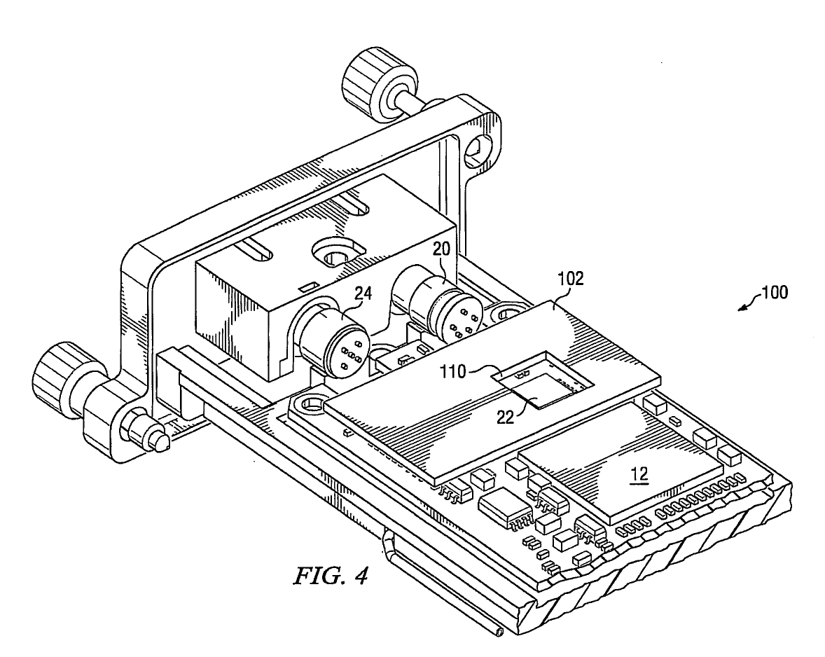

An example implementation of the transceiver 100 of FIG. 2 is shown in greater detail in the perspective views of FIGS. 3 and 4. FIG. 3 illustrates the transceiver 100 with the absorber 102 lifted off of the PCB. FIG. 4 shows the transceiver 100 with the absorber 102 positioned on the PCB. As shown in FIG. 4, the cavity 110 is dimensioned to receive the laser diode driver 22 to effectively isolate the microwave emissions of the driver 22 from other nearby components of the transceiver 100. Significantly, the cavity 110 is not sealed, but is instead open at the top and the bottom. As a result, the high power laser diode driver 22, which produces a significant amount of heat, can be easily thermocoupled to a heat sink via the upper opening of the cavity 110.

As mentioned above, the material of the absorber 102 is preferably selected to absorb microwave emissions. Thus, the absorber 102 is preferably a microwave absorber. The absorber 102 may be implemented by a Ferrite absorber. For instance, the absorber 102 may be implemented by a broadband absorber such as the ECCOSORB FGM from Emerson & Cuming or the MAGRAM (ferrite) DD from Arc Technologies.

Although the illustrated examples include a monolithic absorber 102, persons of ordinary skill in the art will readily appreciate that the absorber 102 may be implemented using two or more components. These multiple components may or may not be physically joined or fixed together.

As mentioned above, the absorber 102 is preferably positioned to overlie at least a portion of the transmit chain 16 and at least a portion of the receive chain 18. However, as shown in FIG. 4, the TOSA 20 and the ROSA 24 are preferably located in one or more planes above the plane of the absorber 102 when the absorber 102 is located in the use position.

Optical transceivers 100 such as those described above may be manufactured by at least partially positioning a converter 12, a transmit chain 16 and a receive chain 18 on a printed circuit board. As discussed above, the transmit chain 16 will typically include a laser diode driver 22 and a TOSA 24. The receive chain 18 will typically include a ROSA 24 to transmit signals to the converter 12 via a differential signal line 26. The transmit chain 16 and the receive chain 18 may be generally parallel to one another.

Subsequently, one or more broadband absorbers 22 are positioned on the PCB such that collectively the absorber(s) at least partially overlie the receive chain 18 and at least partially overlie the transmit chain 16. As discussed above, the absorber(s) 102 preferably define a cavity 110 to receive the laser diode driver 22. The cavity 110 is preferably not closed, such that the manufacturing process can be advanced by thermocoupling the driver 22 to a heat sink such as the transceiver housing.

From the foregoing, persons of ordinary skill in the art will appreciate that optical transceivers and methods of reducing interference in optical transceivers have been disclosed. The disclosed transceivers utilize one or more broadband absorbers to reduce interference between noisy components and components exhibiting low signal strength levels. The absorber(s) are preferably designed to overly one or more portions of the transceiver's PCB and may include one or more cavities to receive and preferably surround noisy components. Because the absorber(s) overlie the PCB, they need not be secured to, printed on or embedded in the PCB, and, thus, do not utilize PCB real estate.

Persons of ordinary skill in the art will readily appreciate that the optical transceivers disclosed herein may be used in a wide range of systems for a wide range of applications. For example, an optical transceiver constructed in accordance with the principles described herein may be used in a communications network to transmit voice or data signals received from a host device. To this end, the transceiver may be coupled to a host device via, for example, a parallel or serial bus.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. An optical transceiver comprising:
a converter;
a laser diode driver in communication with the converter; and
at least one absorber defining a cavity dimensioned to receive the laser diode driver to reduce electromagnetic interference.

2. An optical transceiver as defined in claim 1 wherein the cavity includes an opening to permit thermocoupling of the laser diode driver to a heat sink.

3. An optical transceiver as defined in claim 1 wherein the at least one absorber is at least one of a microwave absorber or a broadband absorber.

4. An optical transceiver as defined in claim 3 wherein the at least one microwave absorber is a ferrite absorber.

5. An optical transceiver as defined in claim 1 further comprising:
a transmit optical sub-assembly (TOSA) in communication with the laser diode driver; and
a receive optical sub-assembly (ROSA) in communication with the converter via a transmission line, wherein the at least one absorber overlies the transmission line.

6. An optical transceiver as defined in claim 5 wherein the at least one absorber reduces interference between the laser diode driver and the transmission line.

7. An optical transceiver as defined in claim 6 wherein the transmission line and the ROSA together comprise a receive chain and the laser diode driver and the TOSA together comprises a transmit chain, the receive chain and the transmit chain being substantially in parallel, the at least one absorber overlying at least a portion of the receive chain and at least a portion of the transmit chain.

8. An optical transceiver as defined in claim 6 wherein the laser diode driver is in communication with the converter via a driver line, the at least one absorber at least partially overlying the driver line.

9. An optical transceiver as defined in claim 1 wherein the converter is a XENPAK converter.

10. An optical transceiver as defined in claim 5 wherein the at least one absorber is positioned beneath the ROSA and the TOSA.

11. A method of reducing interference in an optical transceiver comprising:
at least partially positioning a converter, a transmit chain and a receive chain on a circuit board, the transmit chain including a laser diode driver; and
positioning at least one absorber on the printed circuit board such that the at least one absorber at least partially overlies the receive chain and at least partially overlies the transmit chain.

12. A method as defined in claim 11 wherein the at least one absorber defines a cavity to receive the laser diode driver.

13. A method as defined in claim 11 further comprising thermocoupling the laser diode driver to a heat sink via an opening in the cavity.

14. A method as defined in claim 11 wherein the at least one absorber is at least one microwave absorber.

15. A method as defined in claim 14 wherein the at least one microwave absorber is a ferrite absorber.

16. A method as defined in claim 11 wherein the transmit chain further comprises a transmit optical sub-assembly (TOSA) in communication with the laser diode driver, and wherein the receive chain further comprises a receive optical sub-assembly (ROSA) in communication with the converter via a transmission line, wherein the at least one absorber overlies the transmission line to reduce interference between the laser diode driver and the transmission line.

17. A method as defined in claim 16 wherein the laser diode driver is in communication with the converter via a driver line, the at least one absorber at least partially overlying the driver line.

18. A method as defined in claim 11 wherein the converter is a XENPAK converter.

19. A method as defined in claim 16 wherein the at least one absorber is positioned beneath the ROSA and the TOSA.

20. A system comprising:
a parallel bus; and
an optical transceiver coupled to the parallel bus comprising:
a converter;
a transmit chain in communication with the converter, the transmit chain including a laser diode driver;
a receive chain in communication with the converter; and
at least one absorber at least partially overlying the receive chain and at least partially overlying the transmit chain.

21. A system as defined in claim 20, wherein the at least one absorber defines a cavity dimensioned to receive the laser diode driver to reduce electromagnetic interference.
